(19) United States
(12) Patent Application Publication
(10) Pub. No.: US 2026/0198712 A1
(43) Pub. Date: Jul. 16, 2026

(54) CLEAR VISION CERTIFIED COLLECTIBLES DISPLAY

(71) Applicant: Radix Information Technology, Inc., Bedford, NH (US)

(72) Inventors: Robert Joseph Blaney, Bedford, NH (US); Jane Susan Blaney, Bedford, NH (US)

(21) Appl. No.: 19/132,947

(22) PCT Filed: Dec. 18, 2023
(86) PCT No.: PCT/US2023/084492

§ 371 Date: May 27, 2025

Related U.S. Application Data
(60) Provisional application No. 63/436,653, filed on Jan. 2, 2023.

(51) Int. Cl. A47G 1/12; G09F 1/12

(52) U.S. Cl. CPC A47G 1/12; G09F 1/12

(57) ABSTRACT

The system and method for a clear vision certified collectibles display. The display device provides for unobstructed viewing of a plurality of collectibles from both a front and a back (obverse and reverse sides) view. The display device comprises a rigid surround and a more flexible material used to reversibly hold collectibles within a cell using a plurality of flexible grippers. The flexible material is flowed through channels in the rigid frame and provide for raised cell walls that buffer between consecutive pages. In some cases, the grippers and cell walls are integral with the surround and are a continuous piece. A binder may also be provided for holding a plurality of pages.

### CROSS REFERENCE TO RELATED APPLICATIONS

This Application is a 371 application of PCT/US23/84492 filed Dec. 18, 2023, which claims the benefit of U.S. Provisional Patent Application No. 63/436,653, filed Jan. 2, 2023, the content of each of which are incorporated by reference herein in their entirety.

### FIELD OF THE DISCLOSURE

The present disclosure relates to display and storage devices and more particularly to a display and storage device for collectibles that protects the collectible and allows for unobstructed viewing of a collectible from both sides and in bulk.

### BACKGROUND OF THE DISCLOSURE

When a collector buys a certified coin, or other collectible, they have pride of ownership, and joy in appreciating the beauty of the collectible. Certified collectibles have been sent to one of the recognized grading agencies, firms, or associations that examine the collectible, rate it as a particular grade and/or condition. The graders will note certain attributes and print all of this information on a label that is sealed inside a transparent plastic case along with the collectible. With the collectible and label sealed inside its case, the now “certified collectible” will maintain its condition until the plastic case, or its seal is broken. Due to its shape, the certified collectible is often referred to as a slabbed collectible, or simply a slab. For clarity, collectible coins will be used as a stand-in for all collectibles, and “slab” will be used interchangeably with “certified collectible.”

Collectibles include, but are not limited to, coins, currency, various cards (e.g., baseball cards), ticket stubs, and comics. In the collectible coin example, a collector must store their coins in a secure yet accessible place, especially their high value “certified collectible” coins, (slabs).” This is especially true where, in addition to storage and display, the collector is faced with managing their inventory of collectibles as it is often a sizeable number of collectibles as well as a significant investment. Most often, due to the value of the collectibles themselves, the history or historical context that each individual collectible represents rivals its great beauty. The first question coin collectors (and other collectors) need to address is where to keep this valuable possession. Enjoyment of viewing the collectible while storing the same collectible is secondary.

Currently, collectors of certified collectibles are forced to store their valuable collections in containers (e.g. boxes), in sleeves (e.g., flexible plastic), in wooden “display boxes”, or the like. These methods have a variety of flaws, including: a lack of protection for the collectibles against impacts, a lack of protection against friction from rubbing, a difficulty in viewing multiple items of the collection as a whole, and storage containers made of materials not suited for long term storage.

There is a need for improving the state of the art for storing and displaying collectibles (for simplicity, certified coins will be used to stand for any collectible in the following discussion). Certified coins include coins purchased as certified, or coins purchased from the mint and sent to a certifying entity for coin grading and “slabbing,” which is the process of sealing a certified coin to establish and maintain its grade and appearance.

In the case of collectible coins certified by a certifying agency, there are several top-level certifiers. The top three are the Professional Coin Grading Service (PCGS), the Numismatic Guaranty Company (NGC), and the American Numismatic Association Certification Service (ANACS). PCGS and NGC are the top two graders for coins by volume. PCGS and NGC house release certified collectibles in a plastic housing (slab) that are slightly different in size. NGC slabs their certified collectible coins in transparent plastic containers with the approximate dimensions of 2.375″ wide, 3.375″ high. and 0.375″ thick. The ANACS slab is slightly different in that its top is not square with slightly curved corners but has a top that curves downward across its width to form a top that is a side-to-side edge. The slab designs are all airtight using a label inside the slab with the coin that lists the grade, the year, the mint, and other pertinent characteristics of the coin itself. The plastic housing is sonically sealed so its coin retains its looks for as long as the plastic case remains inviolable. When collectible grading entities became the norm, certification eliminated grade as a point of concern for buyers and sellers because once the coin has a grade certified by a trusted certifying agency, valuations and transactions became a question of price. One could look at comps for the grade of the particular coin and make a valuation or an exchange based upon grade, attributes, and current comparable market prices. Thus, it is important to preserve the state of the certified coin to the extent possible.

There is also a need to link the collectible items, in this case certified coins, to an inventory system. The inventory system for certified coins may contain a coin number, the grade, the cost, various features of the coin, and other pertinent facts. Using an inventory system enables the owner of the certified collectible to mark the holder of the certified collectible with an identification ID. Having a designated space, intrinsic to the holder or storage device that is easy to see, makes locating, auditing, and inventorying owned certified coins an easy process. Auditing based upon numbers eliminates the misidentification of duplicate or many of the same type of coin possible.

One conventional option for storing collectibles is a plastic product that creates pockets for certified coins. It weakly snaps together on one side by utilizing a fold over plastic cover. The product has holes on its left-hand side in order to mount in a standard binder. While this allows for reverse and obverse viewing, the device puts an additional layer of plastic between the viewer's eye and the slab, slabbed coin, and certified coin. These products are prone to popping open causing a catastrophic dumping of certified coins, or other certified collectibles, on the floor. The body of the product is flimsy and extremely flexible due to the type of plastic used and its thinness. This flexibility can cause the product to pop open even when mounted in a binder. In addition to the preceding, the plastic from which the device is made is subject to scratching, which reduces visibility of the collectible coins hosted within the device.

Another conventional storage solution for collectibles is a box or container. Box storage devices can suffer from the same issues as above, plastic pockets product, but with the added problems of weight, size, and configuration differences. After opening the box, viewing is only of one side, and one at a time after removing the coin from the box. To see the other side of a collectible, the collectible must be removed from the box, hand manipulated, viewed, and then returned to storage.

Yet another conventional option is hideaway storage. This device stores coins or other collectibles without affording any viewing of the coins even if the box is made of clear plastic. If clear, only one side of the end coins may be visible on one side. To view the coins, the coins must be removed, viewed, and returned to the box. Then the box is closed and stored by itself or with others. Marks or labels must be made on the box to describe its contents. If the user is searching for a coin, they may have to go through multiple boxes and each coin therein.

Currently, once a certified coin is stored in a twenty-coin box amid other boxes of various sizes, for example, pride of ownership and a desire for security and order greatly reduces the joy of viewing and appreciating the certified coin or other collectible. Even if the certified coin is stored in one of various “see through” devices currently available, there is a layer of plastic that can become cloudy and easily scratched.

Wherefore it is an object of the present disclosure to overcome the above-mentioned shortcomings and drawbacks associated with conventional collectible storage devices.

### SUMMARY OF THE DISCLOSURE

One general aspect includes a collectible display. The collectible display also includes a surround made of a first material forming a plurality of cells, where each of the plurality of cells are sized to accommodate a collectible therein. The display also includes a plurality of grippers made of a second material that are configured to reversibly retain a collectible within each of the plurality of cells.

Implementations may include one or more of the following features. The collectible display where the plurality of grippers is four corner grippers. The collectible display may include two side grippers. The collectible display may include cell walls made of the second material circumscribing each of the plurality of cells and extending above a surface of the surround. The surround is double walled thus forming at least one channel within.

One general aspect includes a collectible display device. The collectible display device also includes a plurality of grippers made of a second material configured to reversibly retain a collectible within a cell.

Implementations may include one or more of the following features. The collectible display where the plurality of grippers is four corner grippers. The collectible display may include two side grippers. The collectible display may include a cell wall circumscribing each of a plurality of cells and extending above a surface of a surround, the surround made of a first material forming the plurality of cells, and the plurality of cells are each sized to accommodate a collectible therein. The plurality of grippers and the cell wall may include a continuous piece of material. Each of the plurality of grippers further may include at least one internal protrusion configured to provide a pressurized connection with a collectible when held within the cell. Each of the plurality of grippers further may include at least one lip edge configured to provide a pressurized connection with a collectible when held within the cell.

One general aspect includes a method of making a collectible display device. The method also includes forming a surround of a first material, the surround may include a plurality of cells each sized to accommodate a collectible therein. The method also includes flowing a second material within at least one channel formed within the surround. The method also includes forming a plurality of grippers from the second material being configured to reversibly retain the collectible within each of the plurality of cells. The method also includes forming a cell wall from the second material, the cell wall circumscribing each of the plurality of cells and extending above a surface of the surround.

Implementations may include one or more of the following features. The method of making a collectible display device may include forming a plurality of recesses on a region of the surround, the recesses being configured to receive a ring of a binder, a post, a barrel nut, or other fastener. Forming of the plurality of grippers and forming the cell wall is of a continuous piece of the second material. The plurality of grippers is four corner grippers and two side grippers.

One general aspect includes a collectible display device a front cover and a back cover having a plurality of pages sandwiched between the front cover and the back cover, each page may include: a surround made of a first material forming a plurality of cells, where the plurality of cells are each sized to accommodate a collectible therein; and a plurality of grippers made of a second material configured to reversibly retain the collectible within each of the plurality of cells. The device also includes a plurality of spacers; and a plurality of fasteners for reversibly connecting the plurality of pages, the plurality of spacers and/or the front cover and the back cover together along an edge.

Implementations may include one or more of the following features. The collectible display device may include cell walls made of the second material circumscribing each of the plurality of cells and extending above a surface of the surround. The plurality of spacers are sized to match a height of the cell walls. The plurality of grippers is four corner grippers and two side grippers.

These aspects of the disclosure are not meant to be exclusive and other features, aspects, and advantages of the present disclosure will be readily apparent to those of ordinary skill in the art when read in conjunction with the following description, appended claims, and accompanying drawings.

### BRIEF DESCRIPTION OF THE DRAWINGS

The foregoing and other objects, features, and advantages of the disclosure will be apparent from the following description of particular implementations of the disclosure, as illustrated in the accompanying drawings in which like reference characters refer to the same parts throughout the different views. The drawings are not necessarily to scale, emphasis instead being placed upon illustrating the principles of the disclosure.

FIG. 1A is a front view of one implementation of a clear vision certified collectibles display according to the principles of the present disclosure.

FIG. 1B is a cross-sectional view along A-A of one implementation of a clear vision certified collectibles display according to the principles of the present disclosure.

FIG. 1C is a side view of one implementation of a clear vision certified collectibles display according to the principles of the present disclosure.

FIG. 1D is a perspective view of one implementation of a clear vision certified collectibles display according to the principles of the present disclosure.

FIG. 1E is a bottom view of one implementation of a clear vision certified collectibles display according to the principles of the present disclosure.

FIG. 2 is a front view of one implementation of a clear vision certified collectibles display according to the principles of the present disclosure.

FIG. 3 is a perspective view of an enlarged portion of one implementation of a clear vision certified collectibles display according to the principles of the present disclosure.

FIG. 4A is a perspective view of one implementation of a first half portion of a corner gripper for a clear vision certified collectibles display according to the principles of the present disclosure.

FIG. 4B is a perspective view of one implementation of a second half portion of a corner gripper for a clear vision certified collectibles display according to the principles of the present disclosure.

FIG. 4C is a perspective view of one implementation of a first half portion of a side gripper for a clear vision certified collectibles display according to the principles of the present disclosure.

FIG. 4D is a perspective view of one implementation of a second half portion of a side gripper for a clear vision certified collectibles display according to the principles of the present disclosure.

FIG. 5 is a perspective view of one implementation of a clear vision certified collectibles display configured to accommodate multiple different types of slabs according to the principles of the present disclosure.

FIG. 6A shows a perspective view of one implementation of a binder for holding implementations of a clear vision certified collectibles display that is open and configured to accommodate multiple different types of slabs according to the principles of the present disclosure.

FIG. 6B shows a cross-sectional view of a portion of one implementation a binder for holding implementations of a clear vision certified collectibles display that is open and configured to accommodate multiple different types of slabs according to the principles of the present disclosure.

FIG. 6C shows a transparent perspective view of one implementation of a binder for holding implementations of a clear vision certified collectibles display that is closed and configured to accommodate multiple different types of slabs according to the principles of the present disclosure.

FIG. 6D shows a perspective view of one implementation of a binder for holding implementations of a clear vision certified collectibles display that is open and contains one or more pages according to the principles of the present disclosure.

FIG. 7 is a flow chart of one implementation of a method of making a clear vision certified collectibles display according to the principles of the present disclosure.

### DETAILED DESCRIPTION OF THE DISCLOSURE

One implementation of the clear vision certified collectibles display of the present disclosure provides for protecting a collectible, for viewing both sides of a collectible without any intervening plastic layer, for viewing a collection of collectibles as a group, and for storing collectibles.

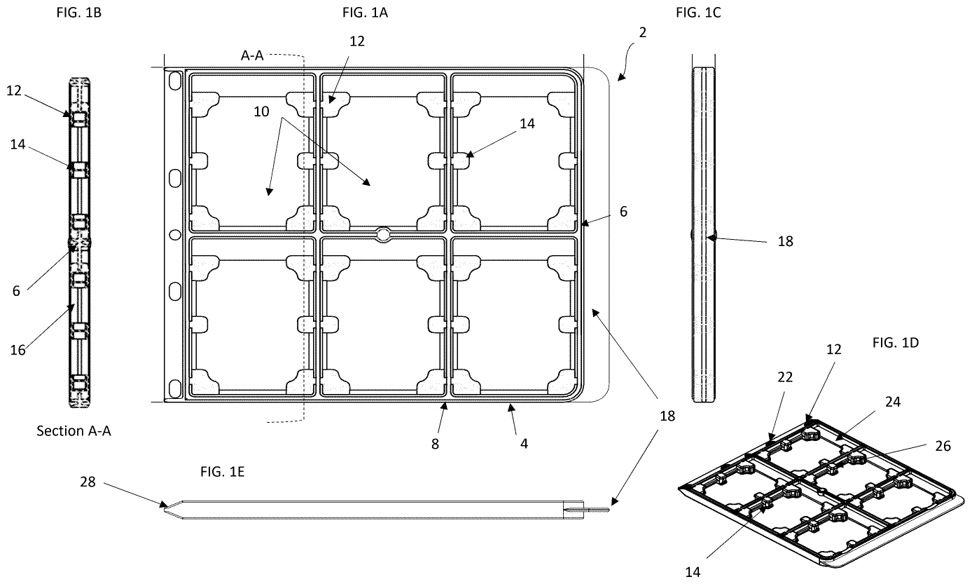

Referring to FIG. 1A, a front view of one implementation of a clear vision certified collectibles display according to the principles of the present disclosure is shown. More specifically, one implementation of the clear vision certified collectibles display of the present disclosure comprises at least one page 2. In some cases, the page 2 comprises a surround 4. In some cases, the surround is double walled forming at least one channel within. In certain implementations, the surround 4 supports the page 2 at a border of the page. In some implementations, the surround 4 is divided horizontally 6 and/or vertically 8 by one or more partitions. In some cases, the surround 4 provides a plurality of walls of equal height as viewed from each side of the page (e.g., from front and back) and is configured to protect the collectibles hosted in/on the page from friction. In some cases, the surround 4 further provides rigidity to the page itself.

In one implementation, a plurality of cells 10 are formed by the surround 4 within the page 2. In some cases, each cell 10, consistent with a size and shape of a collectible to be hosted within the cell, comprises an opening formed in the page that is configured to accommodate a collectible therein (See, e.g., FIG. 5). In one implementation, within each cell on a page there are one or more grippers 12, 14. In certain implementations, a suite of four (4) corner grippers 12 attach to corners of the cell. In some implementations, two (2) additional side grippers 14 are present on either side of a cell.

In one implementation of the clear vision certified collectibles display of the present disclosure, grippers 12, 14 are made of a material that is more pliable (e.g., silicone) as compared to the material used to construct the page 2 and the surround 4 (e.g., plastic). This pliability of the grippers 12, 14 facilitates the mounting of a collectible within a cell. In some cases, grippers 12, 14 are reversibly attached to a page 2 with a portion on either side of the page (see, e.g. FIG. 1B and FIG. 1D).

Still referring to FIG. 1A, in one implementation, based upon the nature and size of the collectibles to be hosted on a page 2, a page will have one or more cells 10. In some implementations, cells 10 comprise an opening formed within the page. In some cases, a page 2 is sized to accommodate a number of collectibles. In certain implementations, cells 10 are larger in dimension than the collectible to be hosted so as to accommodate one or more grippers 12, 14. If there is more than one cell, the cells may be ordered into rows and/or columns, or in a design as appropriate to the size and nature of the collectible hosted.

Referring to FIG. 1B, a cross sectional view along A-A of one implementation of a clear vision certified collectibles display according to the principles of the present disclosure is shown. More specifically, in one implementation the grippers 12, 14 are held into position, in part, by an adherence of both sides of the grippers to the page as well as by material of the grippers physically connecting with each other through gates 16 in the page, thereby making a gripper having a portion on each side of the page. In some cases, the gates 16 are collocated with channels in the surround around the outer border of the page, excluding the extension on the right-side of the page (“the Porch”) 18, and at within each bisection of the page, whether vertical 8, or horizontal 6.

Referring to FIG. 1C, a side view of one implementation of a clear vision certified collectibles display according to the principles of the present disclosure is shown. More specifically, in one implementation of the clear vision certified collectibles display of the present disclosure, there is an extension or porch 18 to the page on the right-hand side and beyond the surround that can be used as a display area, clear vision brand message area, or private labeling area and can also be used to facilitate a user turning the page when it is mounted in a binder, or the like. In some cases, a binder is a book binder, a ring binder, a D-ring type device, or wall or room display. In some cases, there are additional indentations adapted to hold tabs, labels, or the like.

Referring to FIG. 1D, a perspective view of one implementation of a clear vision certified collectibles display according to the principles of the present disclosure is shown. More specifically, in certain implementations a surround forms walls on each side of the page and acts as the border for each cell. In some cases, each side of the page (i.e., front and back when viewed in a binder or the like) will be a mirror of the other side of the page with cells sharing borders with the page surround and neighboring cells. In certain implementations, each cell comprises a flat area, or porch 24, to hold a label or the like. In some cases, there are inner ridges 26 formed at a median of the wall that aid in holding grippers 12, 14 and provide additional rigidity to the surround.

Referring to FIG. 1E, a bottom view of one implementation of a clear vision certified collectibles display according to the principles of the present disclosure is shown. More specifically, a side edge may be angled 28 to provide for ease of turning a page when in a binder or the like.

Certified collectible containers, like that provided for a certified coin, will hereafter be referred to as slabs. In some cases, a slab may be thinner, thicker, longer, wider, or the like, depending on the certifying organization. In one implementation of a clear vision certified collectibles display of the present disclosure varying sized slabs are accommodated within the same page, See, e.g., FIG. 5.

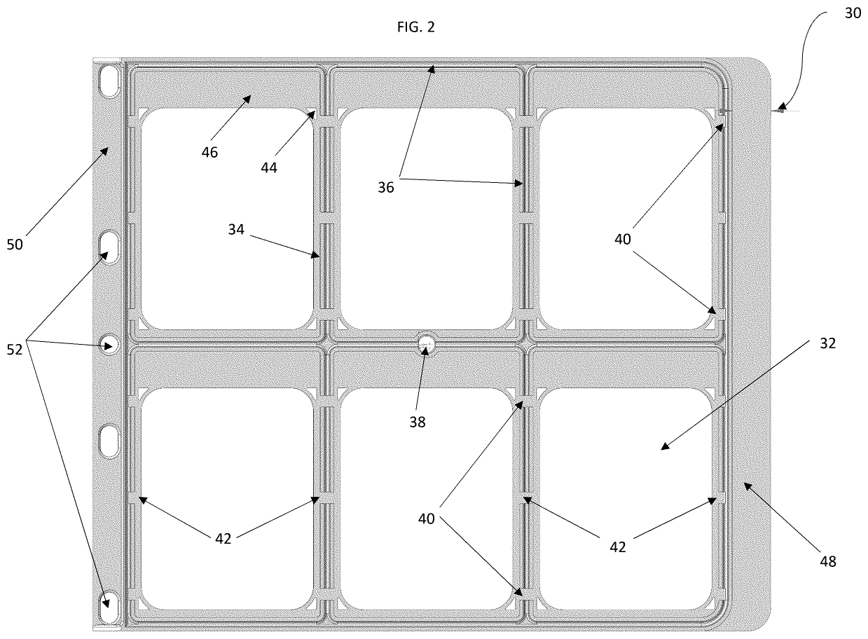

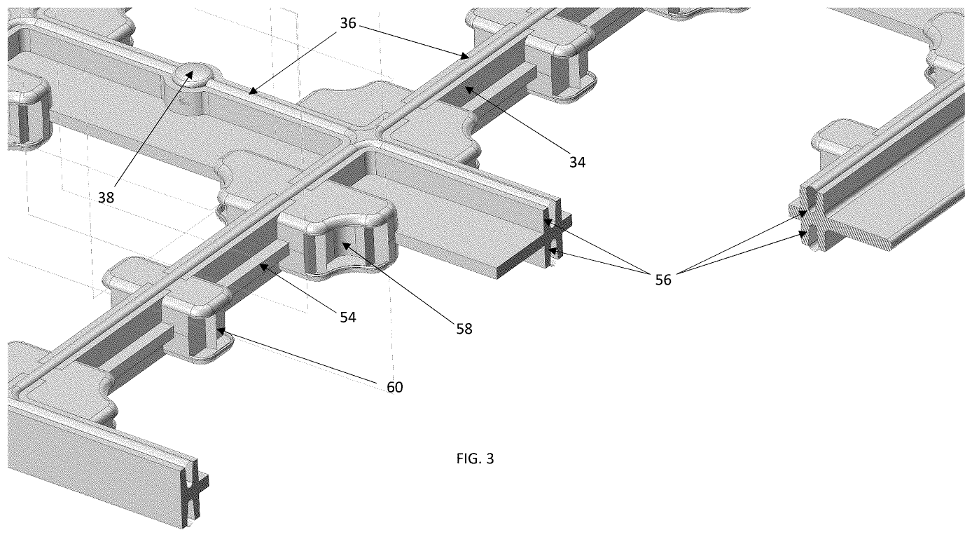

Referring to FIG. 2, a front view of one implementation of a clear vision certified collectibles display according to the principles of the present disclosure is shown. More specifically, a page 30 is shown with a plurality of cells 32 that are formed via bisections in the surround 34. In certain implementations, the materials used to form the grippers and/or surround are synthetic polymers that fall into three specific categories: elastomers are elastic materials with high flexibility and low strength molecular bonds (like rubber); polymer fibers consist of polymer chains that have stronger molecular bonds than elastomers, where fibers are more rigid and less elastic than elastomers and can be composed of both natural and synthetic materials; and thermoplastics, which are more rigid than fibers and elastomers and are distinguished by their ability to retain their molecular structure when exposed to heat. When heated to their melting point, thermoplastics will melt rather than burn, making them ideal for shaping and forming. In one implementation, the surround is formed of a thermoplastic. In one implementation, a range of plastics of clear or colored stock that are inflexible enough to create a base that is strong and consistent enough to mount grippers that hold the collectibles are used. In some cases, the plastic will be inflexible enough so that it will not twist to such a degree that in its appropriate use in viewing a collectibles or collectibles, the display will not cause the escape of one or several collectibles from the grippers. In one implementation, the surround is bisected by a plate (see, e.g., FIG. 3) through which a more pliable material (e.g., an elastomer) may flow via a main feed gate 38. In one implementation, the material will be flexible enough to allow mounting of a collectible in the grippers but not so flexible as to allow the collectible to escape the grippers under normal collectible viewing activities and manipulation of the pages. This elastomeric material will be the material that forms grippers via corner gripper back gates 40 and side gripper back gates 42, and cell walls 36. In certain implementations, the cell walls protrude from both sides (e.g., front and back) of the page and provides for a “bumper” that prevents the pages from making damaging contact with each other and mitigates scratching of a slab held within a cell.

In one implementation, the page 30 contains regions outside the surround 34. One region is used to house recesses to mount the page in various devices. This region 50 of the page is on one side of the page and contains standard binder mounting holes 52. The holes accommodate mounting the page by itself or with other pages in various binder types or mounting schemes in various types of display devices. On the opposite side of the page from the binder mounting holes, the surround may be bisected to form an extension to the plate on the right-hand side. This is an external flat area, or porch 48, to the page on the right-hand side and beyond the surround that can be used as a display area, clear vision brand message area, or private labeling area and can also be used to facilitate turning a page, commonly by the insertion of an finger under the porch of the page above the page that the slab viewer wishes to see.

Still referring to FIG. 2, in one implementation of a clear vision certified collectibles display the page 30 has a plurality of cells 32 and within each cell there is a porch 46. In some cases, the plurality of cells has one or more rounded corners. In certain implementations, corner grippers are formed from flowing of a pliable material via a corner gripper back gate 40 and a corner gate 44. In some cases, the page 30 may have a wide border region, or porch 48, on one side of the page to facilitate turning the pages when in a binder. In some cases, the page 30 may have a region 50 on a side opposite the wide border region, or porch 48, where the region 50 houses a plurality of recesses 52 configured for receiving a ring of a binder, or the like.

Referring to FIG. 3, a perspective view of an enlarged portion of one implementation of a page for a clear vision certified collectibles display according to the principles of the present disclosure is shown. More specifically, the surround 34 is comprised of a first material, and a second material, that is more pliable than the first material, is flowed through the first material via a main feed gate 38 and a series of channels 56 formed within the surround. A plate 54 bisects the surround to form an upper and a lower channel which creates the cell walls 36 on the front and back of each page. The channels 56 are in fluid communication with the gates (See FIG. 2) and are used to form the corner grippers 58 and the side grippers 60.

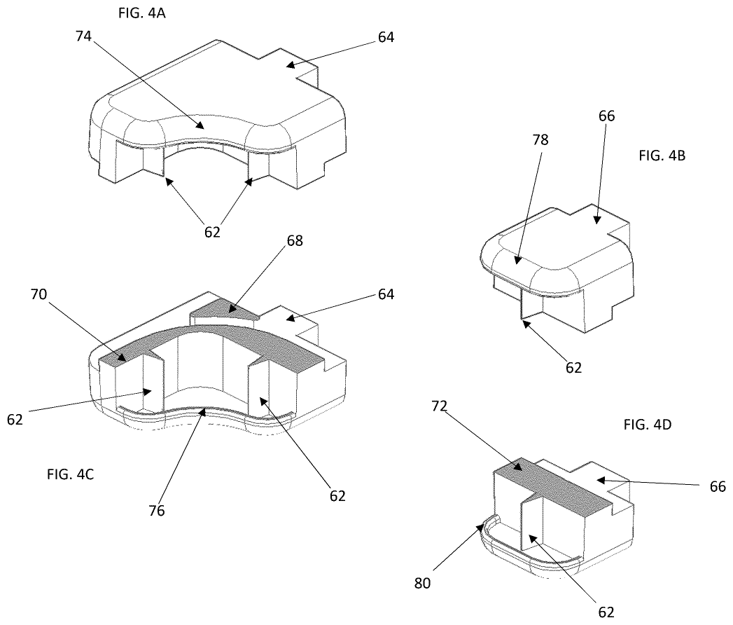

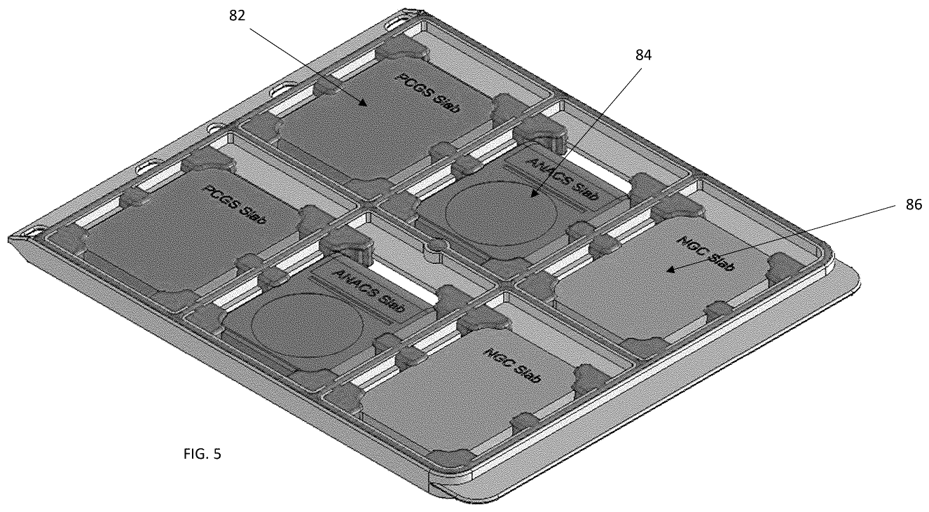

Referring to FIG. 4A, a perspective view of one implementation of a first half portion of a corner gripper for a clear vision certified collectibles display according to the principles of the present disclosure is shown. More specifically, each gripper comprises at least one internal protrusion 62 to facilitate the gripper making a pressurized contact with different size slabs to hold the slabs in place. In certain implementations, the grippers have a lip 74, 78, extending beyond a body of each gripper toward a center of a cell. In certain implementations, the lip is curved to provide for a rounded corner. In some cases, the lip further provides for an additional point of contact with a slab when held within a cell (via a lip edge 76, 80 in FIGS. 4C and 4D, respectively). In one implementation, each gripper has a back protrusion 64 on a back side of each gripper such that grippers on adjacent cells are in fluid connection with each other via the back protrusion and the corner grippers are in fluid connection with each other through a gate located at each corner of each cell. The grippers contact the page as seen by the shaded areas in FIGS. 4C and 4D.

Referring to FIG. 4C, a perspective view of one implementation of a second half portion of a corner gripper for a clear vision certified collectibles display according to the principles of the present disclosure is shown. More specifically, each gripper comprises at least one internal protrusion 62 to facilitate the gripper making a pressurized contact with different size slabs to hold the slabs in place. In one implementation the one or more internal protrusions 62 are in a vertical position in relation to the page's horizontal orientation providing for lateral fit of the collectible within a cell. In certain implementations, the grippers have a lip 74, 78 extending beyond a body of each gripper toward a center of a cell. In certain implementations, the lip is curved to provide for a rounded corner. In some cases, the lip further provides for an additional point of contact with a slab when held within a cell via a lip edge 76, 80. In some cases, the lip edge creates greater contact with the slab to hold the slab in place in the vertical dimension. In one implementation, each gripper has a back protrusion 64 on a back side of each gripper such that grippers on adjacent cells are in fluid connection with each other via the back protrusion. These are formed when the second material is flowed via the back gates. Shaded areas 68, 70 represent areas cut via cross-section between the first half and second half of a corner gripper. These areas are formed when the second material is flowed via the gripper back gate and the corner gate. In one implementation the grippers are integrated and permanently attached to the page. In some cases, the gripper may be reversibly attached.

Referring to FIG. 4B, a perspective view of one implementation of a first half portion of a side gripper for a clear vision certified collectibles display according to the principles of the present disclosure is shown. More specifically, each gripper comprises at least one internal protrusion 62 to facilitate the gripper making a pressurized contact with different size slabs to hold the slabs in place. In certain implementations, the grippers have a lip 78 extending beyond a body of each gripper toward a center of a cell. In certain implementations, the lip is curved. In some cases, the lip further provides for an additional point of contact with a slab when held within a cell (via a lip edge 80 in FIG. 4D). In one implementation, each gripper has a back protrusion 66 on a back side of each gripper such that grippers on adjacent cells are in fluid connection with each other via the back protrusion. The grippers contact the page as seen by the shaded area 72 in FIG. 4D. Both side and corner grippers will also flow their material together and become one part through their attachment as they overhang the porch within each cell.

Referring to FIG. 4D, a perspective view of one implementation of a second half portion of a side gripper for a clear vision certified collectibles display according to the principles of the present disclosure is shown. More specifically, each gripper comprises at least one internal protrusion 62 to facilitate the gripper making a pressurized contact with different size slabs to hold the slabs in place. In one implementation the one or more internal protrusions 62 are in a vertical position in relation to the page's horizontal orientation providing for lateral fit of the collectible within a cell. In certain implementations, the grippers have a lip extending beyond a body of each gripper toward a center of a cell. In certain implementations, the lip is curved. In some cases, the lip further provides for an additional point of contact with a slab when held within a cell via a lip edge 80. In some cases, the lip edge 80 creates greater contact with the slab to hold the slab in place in the vertical dimension. In one implementation, each gripper has a back protrusion 66 on a back side of each gripper such that grippers on adjacent cells are in fluid connection with each other via the back protrusion. These are formed when the second material is flowed via the back gates. Shaded area 72 represents an area cut via cross-section between the first half and second half of a side gripper. This area is formed when the second material is flowed via the gripper back gate. In one implementation the grippers are integrated and permanently attached to the page. In some cases, the gripper may be reversibly attached.

In certain implementations of the clear vision certified collectibles display of the present disclosure, corner and side grippers are formed in halves, where a first half is on top, and a second half is on bottom of each cell. In one implementation, the second material is flowed via gates and channels such that all of the grippers are in fluid connection with each other and the cell walls. In one implementation, grippers attach to the page as a result of heat from the process of molding the grippers, via a welding process, or the like.

In some cases, the corner gripper is radiused to cover a portion of the two sides of a corner angle on the obverse and reverse side of a page that is sufficient to secure a hosted certified collectible. In certain implementations, the corner gripper is designed to cover an angle that may be some other value than 90 degrees or that may be curved.

In some cases, the side grippers attach to the page as described above with reference to the corner grippers. In one implementation, the side gripper covers a portion of the two sides of the obverse and reverse side of a page to secure a hosted certified collectible. The side gripper is designed to be positioned on a side of a cell to provide an increase in holding power of the combined grippers deployed. For example, in one implementation there are four corner grippers. By adding two side grippers on the long sides of a cell, additional holding power and protection for the certified collectible is provided. The side grippers are particularly useful for ANACS slabs and other slabs that deviate in shape or height from the somewhat similar, but not exact, dimensions of the PCGS and NGC Slabs. See, e.g., FIG. 5 elements 82, 84, 86.

In one implementation, an interior recess of a gripper comprises a slot that surrounds an edge of a certified collectible. In certain implementations, the slot comprises a protrusion 62 (e.g., a triangular bump out) that runs from the top to the bottom of the inside of a gripper. In some cases, the protrusion runs from the top to the bottom on any side of a gripper that will be in contact with a slab, e.g., a corner gripper may have two triangular bump outs and a side gripper will have one triangular bump out. The protrusions help address the fact that different certifying entities produce certified collectibles in different sizes. In some cases, the pliability of the grippers, their position within the cells, and the internal slot, the lip bump out, and protrusions make it possible to securely hold collectibles even if their slabs are different sizes and shapes.

In some cases, the effect of the grippers expanding when holding a slab in place, is that the gripper material expands to protect the slabs containing the certified collectibles and provide a layer of protection from rubbing by any object or adjoining page, or from horizontal rubbing or friction. In certain implementations, the page fits into a Safety Deposit Box.

Referring to FIG. 5, a perspective view of one implementation of a clear vision certified collectibles display configured to accommodate multiple different types of slabs according to the principles of the present disclosure is shown. More specifically, three different slabs from three different coin graders are shown prior to insertion into a page. Here, a slab from PCGS 82, a slab from ANACS 84, and a slab from NGC 86, are shown. Each slab varies in dimensions and thickness and the grippers account for this by being constructed of flexible material and by having interior protrusions and or lips to contact the slab when inserted into a cell.

In one implementation, the page is configured to mitigate horizontal, side-to-side rubbing wear on the certifier's slab. The page, the surround, and the grippers get assistance from the material runs (cell walls) extending beyond the surround. This cell wall material is comprised of the same material of the grippers in some cases and provides additional height in softer material than the surround. This material creates a bumper for the surround, which protects the certifier's slab from horizonal or vertical damage from objects larger than the cell.

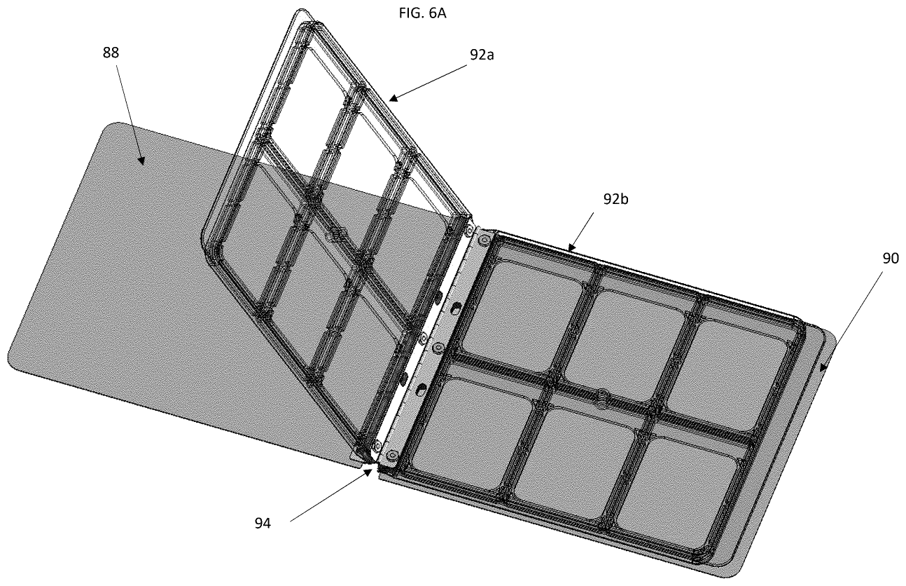

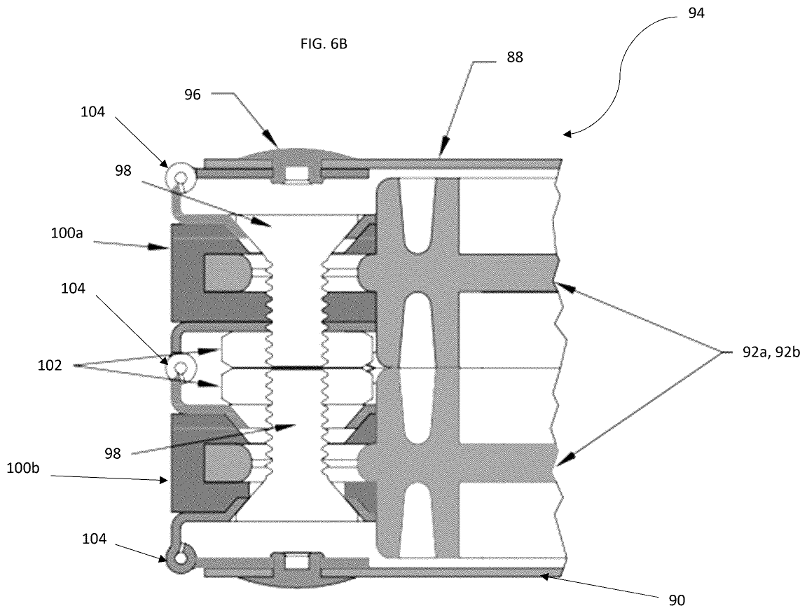

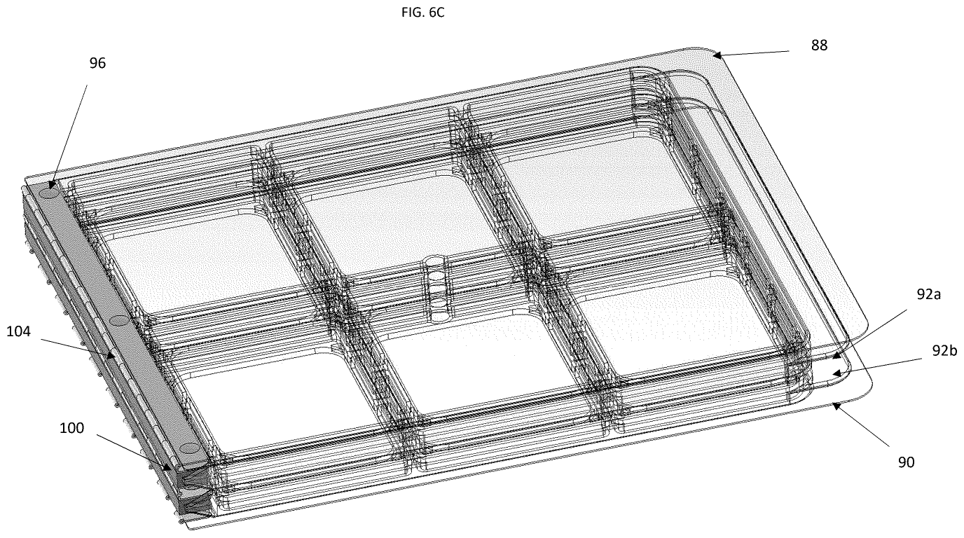

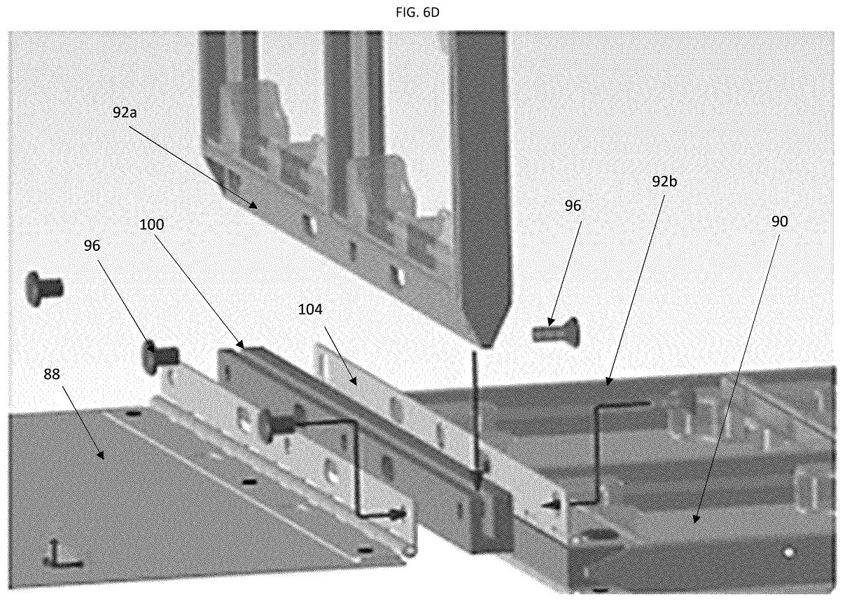

Referring to FIG. 6A, FIG. 6B, FIG. 6C, and FIG. 6D perspective views of one implementation of a binder for holding implementations of a clear vision certified collectibles display configured to accommodate multiple different types of slabs according to the principles of the present disclosure are shown. In one implementation, a binder comprises a front cover 88 and a back cover 90 comprised of a material. In some cases, the cover material is wood, aluminum, leather, faux leather, polymer or plastic. In some cases, the polymer is a thermoplastic or a thermoset. The binder facilitates the unobstructed viewing of the slabs in bulk. In one implementation a lock, a locking cable, a lighted book stand, a lockable carousel, or the like may be provided. In certain implementations a spine cover may be used to encapsulate binder.

More specifically, FIG. 6A shows a perspective view of one implementation of a binder for holding implementations of a clear vision certified collectibles display that is open and configured to hold a plurality of pages is shown. More specifically, pages 92a, 92b, . . . , a front cover 88 and a back cover 90 are held together to form a binder using hinges 94 or the like to connect pages, covers, or both into such a book and to facilitate the opening and closing of such a book and the turning of pages of such a book that is so constructed. In one implementation, hinges may also provide greater security to separating out pages or collectible content of the book. In certain implementations, the binder comprises hinges, filler wood around the binder area, an offset and countersinking screws to form a device that will allow pages to be easily turned.

Referring to FIG. 6B, a perspective view of one implementation of a binder connection area for holding implementations of clear vision certified collectibles, or the like, to a binder is shown. More specifically, spacers 100a and 100b attach through a region of the page on one side of the page and contains standard binder mounting holes 50, to the “binder area” of the clear vision certified collectible display. In one implementation, a front cover 88 has one or more recesses formed therein for accepting a rivet 96, or the like. In one implementation, a back cover 90 has one or more recesses formed therein for accepting a rivet 96, or the like. In one implementation, one or more pages 92a, 92b, . . . are secured between a front cover 88 and a back cover 90 using a plurality of fasteners. In certain implementations, the fasteners are screws 98 and nuts 102. In certain implementations, the certified collectible display has a “binder area” 50 that contains standard holes, and spacers 100a 100b are sized to match the thickness along the length of the binder area 50 so that it is the same thickness as the height of the clear vision certified collectible display page. In some cases, spacers may be firmly attached to the binder mounting area using counter-sunk barrel screws, or the like. The counter-sunk barrel screws or the like may attach through holes in the spacers and matching holes in the binder area securing the spacers to the binding area.

Still referring to FIG. 6B, a type of hinge 104 may be used in the construction of a binder for joining a plurality of pages and covers is shown. In one implementation, a hinge is a piano hinge. The piano hinge is provided as an example but not to the exclusion of the use of other hinges type or of multiple or the same size connected in multiple units, mortised, and non-mortised hinges, and the like materials or hinging techniques.

Referring to FIG. 6C, a transparent perspective view of one implementation of a binder for holding implementations of a clear vision certified collectibles display that is closed and configured to accommodate multiple different types of slabs according to the principles of the present disclosure is shown. More specifically, a front cover 88, a back cover 90 and two representative pages 92a, 92b are shown bound together. In one implementation a plurality of spacers 100 and hinges 104, or the like, are used to secure the plurality of pages within a book. In one implementation one or more forms of fasteners (e.g., rivets 96) are used to hold the covers and pages together. In some cases, a spine cover, or the like, may be used to provide a polished look. In one implementation, a spine cover could be leather or fabric.

One implementation of a method of inserting a page into a binder comprises determining where to add a new page(s). Begin by opening the binder to a preferred position and inserting a new page via its binding area (i.e., the area with the mounting holes), into a new “U” shaped spacer and placing that close by. Have a flat blade and a Philips screwdriver, the supplied hardware of each new binder page to be inserted; “U” shaped spacer, hinge, barrel nuts and flat head screws, or the like. Remove flat head screws at the insertion point from their existing hinge to free the existing hinge from its spacer, creating an opening for a new page. Using new flat head screws freed up in the previous step, connect a new hinge to the now hinge-less spacer. Screw in the flat head screws through the hinge into the barrel nuts that remain in the spacer. There should now be a gap created in your binder that has a free hinge on both sides of the newly created gap. Place the page and its spacer into the gap. Insert new barrel nuts, possibly on the left side of the gap, through the open hinge and into the spacer. This will be the hinge side that is facing its partner's hinge side with flat head screws. Hold the remaining hinge up to the free side of the spacer and insert the flat head screws, one at a time, screwing each into their receiving barrel nut. The new page insertion is now complete. This may repeated.

Still referring to FIG. 6C, one embodiment of the present disclosure is an individual page (e.g., 92a) that has a first spacer 100 on a first side and a second spacer on the opposing side. The first spacer and the second spacer being sized to be slightly thicker than the thickest portion of the individual page so that pages having a pair of spacers may be stacked on top of each other, and the collectibles remain protected. These pages could later be installed in a binder as previously described.

Referring to FIG. 6D, a perspective view of one implementation of a binder for holding implementations of a clear vision certified collectibles display that is open and contains one or more pages according to the principles of the present disclosure is shown. More specifically, a front cover 88, a back cover 90, and two representative pages 92a, 92b are shown bound together. In one implementation a plurality of spacers 100 and hinges 104, or the like, are used to secure the plurality of pages within a book. In one implementation one or more forms of fasteners 96 are used to hold the covers and pages together. In some cases, a spine cover, or the like (not shown), may be used to provide a polished look. In one implementation, the spine cover is leather or fabric.

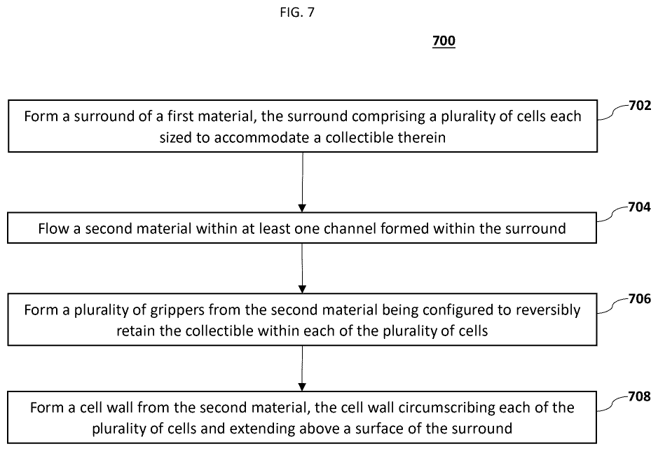

Referring to FIG. 7, a flowchart of one implementation of a method of making a clear vision certified collectibles display is shown. More specifically, a method of making a collectible display device 700 comprises forming a surround of a first material, the surround comprising a plurality of cells each sized to accommodate a collectible therein 702. A second material is flowed within at least one channel formed within the surround 704. A plurality of grippers is formed from the second material being configured to reversibly retain the collectible within each of the plurality of cells 706. In certain implementations, a cell wall is formed from the second material 708, the cell wall circumscribing each of the plurality of cells and extending above a surface of the surround.

Various inventive concepts may be embodied as one or more methods, of which an example has been provided. The acts performed as part of the method may be ordered in any suitable way. Accordingly, implementations may be constructed in which acts are performed in an order different than illustrated, which may include performing some acts simultaneously, even though shown as sequential acts in illustrative implementations.

While various inventive implementations have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive implementations described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain using no more than routine experimentation, many equivalents to the specific inventive implementations described herein. It is, therefore, to be understood that the foregoing implementations are presented by way of example only and that, within the scope of the appended claims and equivalents thereto, inventive implementations may be practiced otherwise than as specifically described and claimed. Inventive implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one implementation, to A only (optionally including elements other than B); in another implementation, to B only (optionally including elements other than A); in yet another implementation, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one implementation, to at least one, optionally including more than one, A, with no B present (and optionally including elements other than B); in another implementation, to at least one, optionally including more than one, B, with no A present (and optionally including elements other than A); in yet another implementation, to at least one, optionally including more than one, A, and at least one, optionally including more than one, B (and optionally including other elements); etc.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one implementation, the features and elements so described or shown can apply to other implementations. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present disclosure.

An implementation is an implementation or example of the present disclosure. Reference in the specification to “an implementation,” “one implementation,” “some implementations,” “one particular implementation,” “an exemplary implementation,” or “other implementations,” or the like, means that a particular feature, structure, or characteristic described in connection with the implementations is included in at least some implementations, but not necessarily all implementations, of the disclosure. The various appearances “an implementation,” “one implementation,” “some implementations,” “one particular implementation,” “an exemplary implementation,” or “other implementations,” or the like, are not necessarily all referring to the same implementations.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various implementations of the disclosure are examples and the disclosure is not limited to the exact details shown or described.

The foregoing description of the implementations of the present disclosure has been presented for the purposes of illustration and description. It is not intended to be exhaustive or to limit the present disclosure to the precise form disclosed. Many modifications and variations are possible in light of this disclosure. It is intended that the scope of the present disclosure be limited not by this detailed description, but rather by the claims appended hereto.

A number of implementations have been described. Nevertheless, it will be understood that various modifications may be made without departing from the scope of the disclosure. Although operations are depicted in the drawings in a particular order, this should not be understood as requiring that such operations be performed in the particular order shown or in sequential order, or that all illustrated operations be performed, to achieve desirable results.

While the principles of the disclosure have been described herein, it is to be understood by those skilled in the art that this description is made only by way of example and not as a limitation as to the scope of the disclosure. Other implementations are contemplated within the scope of the present disclosure in addition to the exemplary implementations shown and described herein. Modifications and substitutions by one of ordinary skill in the art are considered to be within the scope of the present disclosure.

What is claimed:

1. A collectible display, comprising:
a surround made of a first material forming a plurality of cells, wherein each of the plurality of cells are sized to accommodate a collectible therein; and
a plurality of grippers made of a second material being configured to reversibly retain a collectible within each of the plurality of cells.

2. The collectible display according to claim 1, wherein the plurality of grippers is four corner grippers.

3. The collectible display according to claim 2, further comprising two side grippers.

4. The collectible display according to claim 1, further comprising cell walls made of the second material circumscribing each of the plurality of cells and extending above a surface of the surround.

5. The collectible display according to claim 1, wherein the surround is double walled thus forming at least one channel within.

6. A collectible display device, comprising:
a plurality of grippers made of a second material configured to reversibly retain a collectible within a cell.

7. The collectible display device according to claim 6, wherein the plurality of grippers is four corner grippers.

8. The collectible display device according to claim 7, further comprising two side grippers.

9. The collectible display device according to claim 6, further comprising a cell wall circumscribing each of a plurality of cells and extending above a surface of a surround, the surround made of a first material forming the plurality of cells, and the plurality of cells each being sized to accommodate a collectible therein.

10. The collectible display device according to claim 6, wherein each of the plurality of grippers further comprise at least one internal protrusion configured to provide a pressurized connection with a collectible when held within the cell.

11. The collectible display device according to claim 6, wherein each of the plurality of grippers further comprise at least one lip edge configured to provide a pressurized connection with a collectible when held within the cell.

12. The collectible display device according to claim 9, wherein the plurality of grippers and the cell wall comprise a continuous piece of material.

13. A method of making a collectible display device, comprising:
forming a surround of a first material, the surround comprising a plurality of cells each sized to accommodate a collectible therein;
flowing a second material within at least one channel formed within the surround;
forming a plurality of grippers from the second material, the plurality of grippers being configured to reversibly retain the collectible within each of the plurality of cells; and
forming a cell wall from the second material, the cell wall circumscribing each of the plurality of cells and extending above a surface of the surround.

14. The method of making a collectible display device according to claim 13, further comprising forming a plurality of recesses in a region of the surround, the plurality of recesses being configured to receive a ring of a binder, a post, a barrel nut, or other fastener.

15. The method of making a collectible display device according to claim 13, wherein forming the plurality of grippers and forming the cell wall is of a continuous piece of the second material.

16. The method of making a collectible display device according to claim 13, wherein the plurality of grippers is four corner grippers and two side grippers.

17. A collectible display device, comprising:
a front cover and a back cover having a plurality of pages sandwiched between the front cover and the back cover, each page comprising:
a surround made of a first material forming a plurality of cells, wherein the plurality of cells are each sized to accommodate a collectible therein; and
a plurality of grippers made of a second material configured to reversibly retain the collectible within each of the plurality of cells;
a plurality of spacers; and
a plurality of fasteners for reversibly connecting the plurality of pages, the plurality of spacers and/or the front cover and the back cover together along an edge.

18. The collectible display device according to claim 17, further comprising cell walls made of the second material circumscribing each of the plurality of cells and extending above a surface of the surround.

19. The collectible display device according to claim 18, wherein the plurality of spacers is sized to match a height of the cell walls.

20. The collectible display device according to claim 17, wherein the plurality of grippers is four corner grippers and two side grippers.
